(19) United States
(12) Patent Application Publication
(10) Pub. No.: US 2005/0161857 A1
(43) Pub. Date: Jul. 28, 2005

(54) Polymeric fibre and method for making same

(76) Inventors: Allan Gerald Arthur Coombes, Warwick (GB); Matthew Richard Williamson, Dorset (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/510,842

(22) PCT Filed: Apr. 11, 2003
(86) PCT No.: PCT/GB03/01555

(30) Foreign Application Priority Data
Apr. 11, 2002 (GB) 0208418.4

(51) Int. Cl. C08J 5/00

(52) U.S. Cl. 264/172.15; 264/178 R; 264/331.12

(57) ABSTRACT

A method of producing a polymeric fibre comprising dissolving at least one fibre forming polymer in a solvent so as to form a polymer solution, and feeding the polymer solution under gravity through an orifice directly into a non-solvent whereby to cause formation of a polymeric fibre in the non-solvent. The method of producing a poly(ε-caprolactone) fibre comprising dissolving poly(ε-caprolactone) polymer in a solvent whereby to form a poly(ε-caprolactone) solution, and feeding the poly(ε-caprolactone) solution through an orifice directly into a non-solvent whereby to form said poly(ε-caprolactone) fibre.

This invention relates to a novel method of producing a polymeric fibre, particularly but not exclusively, a poly(ε-caprolactone) (PCL) fibre, for use in the production of biomedical implants and cell-support matrices utilised in tissue engineering, or in biodegradable textiles.

Tissue engineering is currently attracting great interest because of the prospects for obtaining ‘living’ tissue replacements and thereby reducing the reliance on donor tissue and organs. Tissue engineering involves the design and manufacture of implants for repair, support, augmentation or replacement of damaged or diseased tissues and organs such as bone and skin. In one approach, cells are seeded onto 3-D scaffolds or matrices ex-vivo. The cell-scaffold construct is subsequently implanted where cell development continues to regenerate new tissue. The microstructure and architecture of the scaffold, together with the surface chemistry exert profound effects on cell distribution, morphology and alignment and, importantly, cell proliferation and differentiation which underpins correct tissue development (Freed, L. E. and Novakovic, G. Culture of organised cell communities, Adv. Drug. Del. Rev. 33 (1998) 15-30. Hubbell, J. A. Biomaterials in tissue engineering, Biotechnology, 13 (1995) 565. Marler, J. J. Transplantation of cells in matrices for tissue regeneration, Adv. Drug Del. Rev. 33 (1998) 165-182).

The scaffold component of tissue engineered constructs has been produced using a variety of techniques including fibre bonding (Mikos, A. G et al, Preparation of PGA bonded fibre structure for cell attachment and transplantation, J. Biomed. Mater. Res. 27 (1993) 183), solid free-form fabrication (Koegler et al, Solid free-form fabrication of bone regeneration devices, 1st Smith and Nephew International Conference, York, July 1997) and salt extraction (de Groot, J. H et al, Use of porous PU for meniscal reconstruction and meniscal prostheses, Biomaterials 17 (1996) 163-173). In particular, inherently porous, fibre constructs of various designs based on woven, knitted and non-woven technologies have been widely investigated for improving cell attachment and tissue infiltration of the scaffold. (Wintermantel, E. et al, Tissue engineering scaffolds using superstructures, Biomaterials 17 (1996) 83-91). The design and production advantages associated with polymer fibres have already led to the use of both natural and synthetic fibres for a wide range of tissue repair applications involving bone and cartilage, skin substitutes, nerve regeneration (Marler, J. J. supra) and blood vessels (Hanson, S. J, Mechanical evaluation of resorbable copolymers for end use as vascular grafts, ASAIO Trans. 34 (1998) 789-93). Indeed the early observations of favourable cell growth on silk fibres stimulated much of the research into biomaterials-cell interaction. Fibrous mats or meshes of synthetic resorbable polymers such as polyglycolic acid (PGA) or poly(DL lactide co-glycolide) (PLG) are being investigated extensively as scaffold materials for seeded cells in tissue engineering (Freed, L. E and Novakovic, G. supra, Hubbell, J. A. supra, Marler, J. J. supra). One production technique entails heating of a wad of PGA fibres in a mould to produce point welding between the individual fibres (Mikos, A. G et al supra). On cooling the mesh retains the shape of the mould and is used as a template to support cell adhesion and tissue infiltration.

Resorbable synthetic fibres such as ‘Dexon’ (produced from PGA) and polyglactin have been used for many years as suture materials. Resorbable sutures are designed to maintain wound closure for fairly short times of around 6 weeks to coincide with the relatively rapid repair processes in skin and soft tissues. Thus the resorption rate of the suture is correspondingly rapid and the mechanical properties decline over approximately 2 weeks to promote natural strengthening of the repair site. The high resorption rate of PGA and some PLG copolymers of 4-6 weeks renders them highly suitable for application as sutures and scaffolds for soft tissue repair but presents problems in applications such as bone repair which require longer times for tissue growth (about 6 weeks) and remodelling (about 6 weeks). Fast-resorbing polymers such as PGA and PLG also display high shrinkage values (Coombes, A. G. A. and Meikle, M, Resorbable synthetic polymers as replacements for bone graft, Clinical Materials 17 (1994) 35-67) which can mean that anchorage-dependent cells and tissues are not presented with a stable substrate for laying down extra-cellular matrix (ECM). In addition, the production of acidic degradation species by fast-resorbing polymers can compromise tissue repair (Kyriacos, A et al, Sterilisation, toxicity, biocompatibility and clinical, applications of PLA/PGA copolymers, Biomaterials 17 (1996) 93-102).

Slow-resorbing fibres based on polylactic acid (PLA), having resorption times in excess of one year, provide extra scope for producing implants matched to tissue repair rates and characteristics. The production of PLA fibres by melt spinning and solution spinning (see below) has been described (Eling, B, Biodegradable materials of poly(L-lactic acid) 1, Polymer 23 (1982) 1587-93. Leenslag, J. W et al, Resorbable materials of poly(L-lactide) V Influence of secondary structure on the mechanical properties and hydrolysability of poly(L-lactide) fibres produced by a dry spinning method, J. App. Polym. Sci. 29 (1984) 2829-2842. Fambri, L. et al, Biodegradable fibres. Poly-L-lactic acid fibres produced by solution spinning, J. Mater. Sci. Mater. in Medicine. 5 (1994) 679-683) and the mechanical, thermal and morphological properties have been detailed.

Fibre Spinning

Fibre spinning may be broadly divided into two categories, melt spinning and solution spinning. In melt spinning, the molten polymer is forced through a spinneret and the jet of molten polymer is cooled to form solid threads. These threads are subjected to a drawing procedure to control chain orientation and fibre tensile properties. Solution spinning is based upon extrusion under pressure of concentrated polymer solutions. In dry solution spinning, the extruded filaments are dried to remove solvent, whereas in wet solution spinning the filaments are extruded into a non-solvent to precipitate the polymer in the form of a thread. Solution spinning of the poly(α-hydroxy acids) such as PLA normally requires high solution viscosities to enable extrusion of a filament, prior to drawing. High strength polyethylene (PE) fibres have been spun from solutions undergoing shear flow in a Couette apparatus rather than by extrusion through an orifice. Investigations demonstrated the marked influence of spinning temperature on fibre strength and stiffness occasioned by the improvement in polymer chain alignment and reduction of the chain folded element (‘kebab structure’) in the fibrous ‘shishkebab’ structures which made up the fibre. In another approach, high modulus, high strength fibres have been produced by controlled drawing of PE gels (Smith, P et al, Polymer Bulletin. 1 (1979) 733) or poly(vinyl alcohol) gels (Cebe, P and Grubb, D, Gel drawn fibres of poly(vinyl alcohol), J: Mater. Sci. 20 (1985) 4465-4478).

Fibres for Drug Delivers

Hollow fibres have been produced as reservoirs for drugs to achieve controlled delivery on implantation (Schakenraad, J. M et al, Biodegradable hollow fibres for the controlled release of drugs, Biomaterials, 9 (1988) 116-120). Hollow PLA fibres were spun using a ‘dry-wet’ coagulation spinning process using a 15% PLA, 80% dioxane, 5% polyvinylpyrrolidone solution at 50° C. Water was used as the internal and external coagulant. The hollow fibres (0.72 mm OD, 0.47 mm ID) were subsequently filled with levonorgestrel in castor oil (25% w/w) and heat sealed to provide lcm long, injectable devices.

Potential Advantages of PCL Fibres

PCL fibres would provide a useful, low cost, alternative to PLA. PCL is noted for its biocompatibility (Pachence, J. M., Kohn, J., Biodegradable Polymers in Principles of Tissue Engineering pp263-277, Eds. Lanza, R. P., Langer, R., Vacanti J., Academic Press 2000, 2^{nd} Edition) and like PLA, PCL is a slowly degrading poly(α-hydroxy acid) which would allow more time for regenerating tissue to establish. PCL (in moulded form) exhibits lower tensile modulus (0.3 GPa) and strength (19 MPa) than PLA (4 GPa, 70 MPa) but higher extensibility which presents opportunities for adjusting the compliance of cardiovascular implants for example. PCL films have been shown to provide a favourable substrate for growth of bone cells (Ali, S. A et al, Mechanisms of polymer degradation in implantable devices 1. PCL, Biomaterials 14 (1993) 648-656) and the polymer has been applied as the matrix component in composites intended for bone repair (Marra, K. G et al, In vitro analysis of biodegradable polymer/hydroxyapatite composites for bone tissue engineering, J. Biomed. Mater. Res. 47 (1999) 324-35).

PCL fibres have been produced by melt spinning at 210° C. followed by drawing at 45° C. to give draw ratios ranging from 5-9 (Mochizuki, M et al, Hydrolysis of PCL fibres by lipase, J. App. Pol. Sci. 55 (1995) 289). Tetracycline-containing PCL fibres have been investigated for periodontal therapy for example (Goodson, J. M et al, Monolithic tetracycline-containing fibers for controlled delivery to periodontal pockets, J. Periodontol. 54 (10) (1983) 575-9) and mention has been made of 0/60/120° patterns of PCL fibres forming scaffolds for tissue engineering (Hutmacher, D. W, Tissue engineering research. Medical Device Technology, 1 (2000) 33). These studies both featured melt spun fibres.

It is an object of the present invention in one aspect to provide a novel method of producing a wet spun polymeric fibre.

According to a first aspect of the present invention there is provided a method of producing a polymeric fibre comprising:
(i) dissolving at least one fibre forming polymer in a solvent so as to form a polymer solution, and
(ii) feeding the polymer solution under gravity through an orifice directly into a non-solvent whereby to cause formation of a polymeric fibre in the non-solvent.

It will be understood that the viscosity of the polymer solution must be sufficiently low to allow the solution to pass through the orifice under gravity. This may be achieved by having a relatively low concentration of the at least one polymer in the solution, or through the inherently low viscosity characteristics of the at least one polymer.

It will be further understood that the choice of solvent/non-solvent will depend upon the particular polymer(s) being used. Preferably, the non-solvent is chosen such that the polymer solution is denser than the non-solvent, thereby allowing free flow of the polymer solution stream and avoiding floatation of the polymer solution on the non-solvent.

As used herein, the term “non-solvent” includes liquids in which the polymer is sparingly soluble. The key functional requirement is that the polymer is sufficiently less soluble in the non-solvent to induce fibre formation therein. Thus the term “non-solvent” includes within its scope mixtures of solvents and non-solvents which have sufficiently low solubility for fibre formation.

Preferably, said at least one fibre-forming polymer is selected from a linear aliphatic polyester e.g. poly(ε-caprolactone), a polylactide, a polyglycolide, their copolymers with (i) other aliphatic polyesters, e.g. poly(DL lactide co-glycolide), poly(glycolide ε-caprolactone), and (ii) monomers other than linear aliphatic esters e.g. poly(glycolide trimethylene carbonate), poly(L-lactic acid-L-lysine), poly(DL-lactide-urethane), PLA/PEO copolymers, poly(ester-amide), a polyanhydride, a polyorthoester, a poly(ester-ether) e.g. poly-p-dioxanone, a polyphosphazine, PHB, PHV and their copolymers, a poly(β-malic acid), a poly(amino acid) e.g. poly(L-lysine), an aliphatic or an aromatic polycarbonate e.g. poly(ethylene carbonate) and their copolymers with any of the aforementioned polymers.

Blending of polymers to optimise material properties has been applied extensively in biomedical materials and drug delivery research. The method of the invention is potentially useful for blending one or more different polymers (synthetic or-natural) to obtain different physico-chemical characteristics so as to control the pattern of drug release from the fibre or to modulate cell interaction. It is known that the degradation rate of the poly(α-hydroxy acids) such as PLG, for example, can be varied from several weeks to over a year by copolymerisation, control of molecular weight, crystallinity and morphology. Blending of such polymers would allow control of the degradation characteristics of the product fibres.

It will be understood that the choice of polymers to be blended will depend upon the desired characteristics of the formed fibre. Thus, step (i) may include the addition of at least one additional polymer. Useful synthetic polymers include copolymers produced from lactide and non-lactide monomers such as lactones (e.g. epsilon caprolactone) or ethylene glycol, PMMA, PU, copolymers containing a thermoplastic elastomer or hydrogel forming copolymers such as poly(hydroxyethyl methacrylate).

Further useful polymers include polyethylene glycol (PEG), polyethylene oxide (PEO) copolymers of poly(ethyleneoxide)-poly(propylene oxide) (Pluronic, Tetronic copolymers), polyvinylpyrrolidone (PVP) resulting in fibres having a water soluble phase. Such compositions may be useful for controlling the rate and time of drug release from the polymer matrix.

Step (ii) may be effected by feeding the polymer solution through the orifice simultaneously with a pre-formed fibre, such that the resultant fibre comprises a core of the pre-formed fibre surrounded by a fibre formed from the polymer solution. The pre-formed fibre may be, for example, polyester (e.g. Dacron (Trade name)).

Where the at least one fibre-forming polymer is poly(ε-caprolactone), said solvent is preferably selected from one or more of acetone, ethyl acetate, dichloromethane, chloromethane and chloroform. Most preferably, said solvent is acetone.

Where the at least one fibre-forming polymer is poly(e-caprolactone) said non-solvent is preferably selected from one or more of methanol, ethanol and water. Most preferably, said non-solvent is methanol.

Preferably, said solvent and non-solvent are miscible.

Preferably, the method includes an additional step of introducing into the solvent one or more additives prior to step (ii).

Said additional step may be effected prior to, concomitantly with or after step (i). The or each additive may be chosen so as to vary one or more properties of the fibre such as degradation rate, density, thermal, mechanical, morphological chemical characteristics and cell growth properties. The or each additive may be solid, particulate or fibrous and substantially insoluble in the polymer and solvent, or the or each additive may be liquid and/or soluble in the polymer and/or solvent.

Preferably, said additional step is effected by low shear mixing. Preferably, after step (ii) said additive(s) is/are homogeneously distributed in the fibre.

The process of the present invention is effected under low shear and low temperature conditions. Thus, additives which are temperature sensitive (such as agents which may be deactivated, denatured or which decompose) and those which are deactivated under high shear may be incorporated in said additional step. It has not previously been viable to incorporate such additives in melt spun (high temperature) or traditional solution spun (high pressure/shear) processes. Examples of such additives include peptides, proteins and DNA pharmaceuticals.

Examples of useful additives include natural materials such as polysaccharides (e.g. inulin, starch, dextran, cellulose and derivatives), sugar spheres, extra-cellular matrix components such as glycosaminoglycans and proteins (e.g. collagen, gelatin and albumin).

Other useful additives include bioceramics such as hydroxyapatite (HA), carbonate hydroxyapatite, tricalcium phosphate (TCP), carbon, calcium carbonate, and ‘Bioglass’ (a highly bioactive glass particulate material used in bone repair).

Examples of useful synthetic polymer additives include PMMA powders such as those used in bone cements for implant fixation, polyesters (PET), biodegradable polymers such as PLA and PLG, polyorthoesters, polyanhydrides and oligosaccharide ester derivatives (OEDs).

Examples of useful discontinuous fibrous additives include alumina, carbon and synthetic polymers such as polyester (‘Dacron’), PGA and polydioxanone (PDS).

It is known that protein adsorption onto biomedical implants in vitro and in vivo directly influences initial cell attachment and adhesion and the subsequent stages of cell spreading, proliferation and differentiation (Hubbell, J. A. supra). Survival of many cell types-including fibroblasts and endothelial cells requires integrin mediated adhesion to extracellular matrix proteins. Modification of the surface of polymeric fibres by cell-adhesion proteins such as fibronectin or peptides having cell binding properties provide advantages for tissue engineering.

Thus, the additional step preferably includes the introduction of at least one cell adhesion molecule for modifying the fibre surface (e.g. by adsorption). The cell adhesion molecule may be selected from: collagen, gelatin, fibronectin, vitronectin, laminin, elastin and their synthetic analogues such as the protein-silk polymers or conjugates of such molecules with hydrophobic moieties, synthetic analogues of biomolecules containing cell binding sequences (such as the RGD sequence), antibodies having affinity for specific cell receptors of interest and molecules having affinity for cell surface polysaccharides.

The use of various growth factors has been investigated for regeneration of skin, bone, cartilage, nerves and blood vessels. However, there is a need to control the time, extent and sequence of growth factor delivery to responsive cells to mimic physiological processes and to maximise the therapeutic potential of these agents. The controlled delivery and presentation of polypeptide growth factors, or DNA which encodes for these factors, by polymeric fibres would be advantageous for production of tissue engineered constructs.

Thus, the additional method step preferably includes the introduction of at least one additive selected from polypeptide growth factors such as transforming growth factor-β (TGF-β), VEGF, EGF, BMP, IGF, or DNA encoding for polypeptide growth factors, their synthetic analogues or conjugates with other molecules such as PEG.

Further useful additives include, vaccine antigens, therapeutic antibodies, DNA, RNA, oligonucleotides, anti-coagulants, anti-cancer, anti-inflammatory, anti-bacterial and anti-viral agents, thrombolytic agents, hormones and decalcified freeze-dried bone (DFDB). Other useful additives include bioactive compounds for veterinary and agricultural use (e.g. pesticides, plant nutrients and growth hormones).

It will be understood that incorporation of such molecules into the body of the fibre facilitates controlled release of said molecules, the rate of release being controllable by one or more other additives as previously described.

The or each additive may comprise one or more active agent and a carrier vehicle. Examples of such carrier vehicles include but are not limited to: sugar spheres or spheres produced from polysaccharides such as dextran, inulin, starch, cellulose and derivatives, proteins such as gelatin and albumin. Examples of suitable synthetic carrier particles include synthetic non-resorbable polymeric particulates, microspheres and nanospheres (e.g. polyamide, PET, PMMA) and resorbable polymer particulates, microspheres or nanospheres (e.g. PLA), carbon, bioceramics (e.g. hydroxyapatite) and magnetic particles. The active agent(s) may be incorporated into the carrier vehicle or coated thereupon.

The method may comprise a further additional step (iii) of applying at least one additive to the surface of the fibre formed in step (ii).

Step (iii) may be in addition to or instead of the aforementioned additional step and the or each additive used in step (iii) may be selected from any of those already referred to above.

According to a second aspect of the present invention there is provided a fibre producible by the method according to the first aspect.

According to a third aspect of the present invention there is provided a method of producing a poly(ε-caprolactone) fibre comprising:
(i) dissolving poly(p-caprolactone) polymer in a solvent whereby to form a poly(ε-caprolactone) solution, and
(ii) feeding the poly(ε-caprolactone) solution through an orifice directly into a non-solvent whereby to form said poly(F-caprolactone) fibre.

Preferably, said poly(ε-caprolactone) solution is passed through the orifice under gravity.

The method according to the third aspect may include either or both of the additional steps described in relation to the first aspect. It will therefore be understood that any of the solvents, non-solvents and additives mentioned in the context of the first aspect are also applicable to the third aspect. However the solvent is preferably acetone. The non-solvent is preferably methanol.

According to a fourth aspect of the present invention there is provided a poly(ε-caprolactone) fibre producible by the method according to the third aspect.

Examples of fibres according to the present invention will now be described, by way of example only, with reference to the accompanying drawings in which:

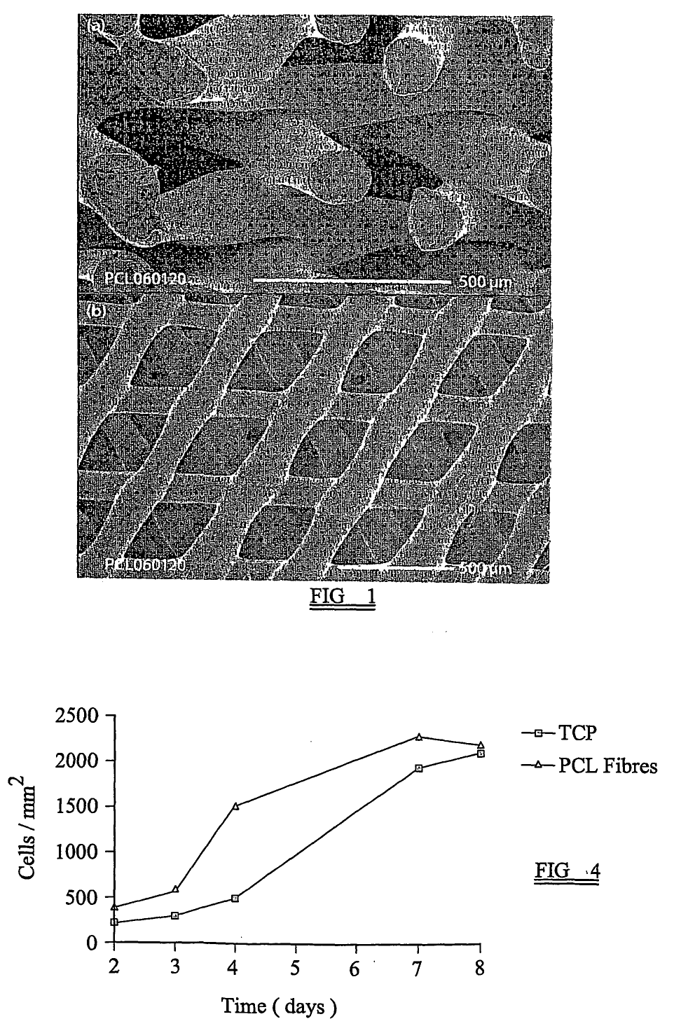

FIG. 1 is an electron micrograph showing surface topography of PCL melt-spun fibres for comparison with the fibres of the present invention,

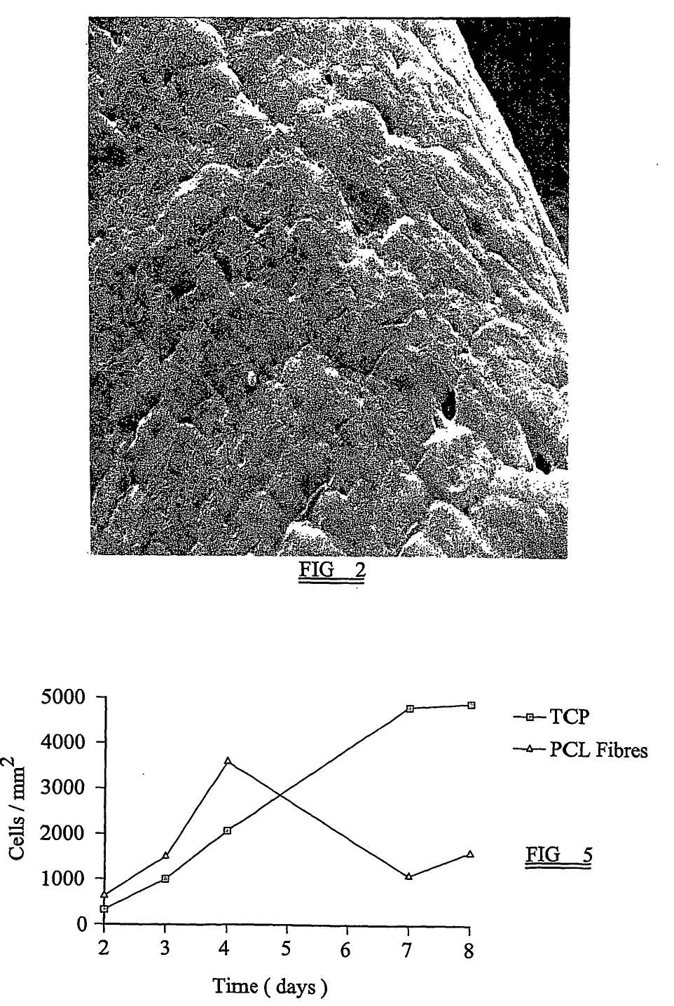

FIG. 2 is an electron micrograph showing the surface topography of an as-spun PCL fibre,

FIG. 3 is a plot of cell proliferation against time for PCL fibres made in accordance with the present invention containing progesterone versus TCP and PCL controls

FIGS. 4 to 6 are graphs of cell density plotted against time for-cells grown on PCL fibres and tissue culture plastic as control, and

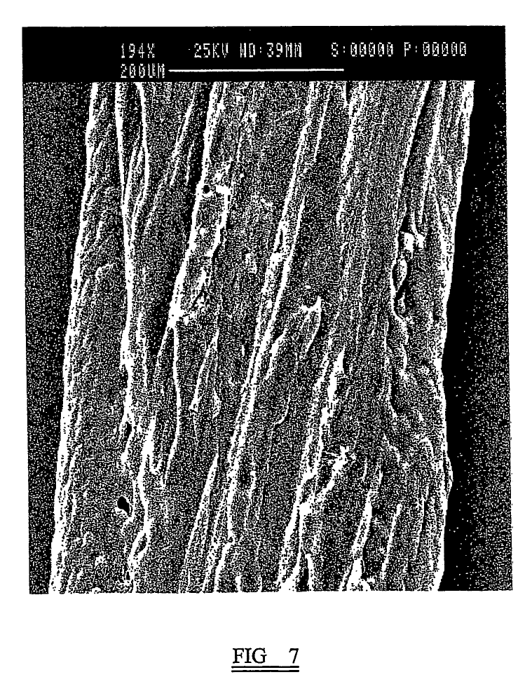

FIG. 7 is an electron micrograph showing the surface topography of a surface modified PCL fibre.

### METHODS

Unless otherwise stated, poly(ε-caprolactone). (PCL) fibres were produced from polymer of average molecular weight (Mw) 115,000 (Mean molecular weight (MW) 50,000 based on measurement of reduced viscosity).

Fibre macroscopic shape and cross-sectional dimensions were determined using an optical microscope having a calibrated eyepiece graticule. Fibre morphology was examined using scanning electron microscopy (SEM).

Fibre tensile properties (Young Modulus (E-modulus), ultimate tensile strength (UTS) and elongation at break) were measured using a Hounsfield H10KS tensile testing machine. Fibre extension was measured using 25 mm length specimens and approximated from the crosshead movement. Testing was performed at a crosshead speed of 15 mm/minute.

It is well known that secondary processing operations (fibre draw ratio and drawing temperature) influence fibre properties. The effect of cold drawing on fibre properties was evaluated by controlled extension of fibre samples at room temperature at a rate of 15 mm/min using the tensile testing machine. The tensile properties of drawn fibres were subsequently determined as described above.

The thermal characteristics of PCL fibres (melting point (Tm) and percentage crystallinity) were determined by differential scanning calorimetry (DSC) using a heating rate of 10° C./min. The latter property was estimated from area under the curve measurements using a value of 139.5 J/gm for the heat of fusion of fully crystalline PCL (Pitt et al, Aliphatic polyesters. 1, The degradation of poly(ε-caprolactone) in vivo, J. App. Polym. Sci. 26 (1981) 3779-3787). Surface modification of PCL fibres with protein was achieved by adsorption of gelatin from 5, 10 and 20% w/v solutions respectively. Fibres (30 mg) were dip coated and dried overnight at room temperature. The coated fibres were washed by immersion in 70% ethanol then water for several minutes.

The amount of adsorbed gelatin on the fibres was determined directly using the BCA total protein assay. Coated fibres (30 mg) were immersed in bicinchonic acid protein (BCA) reagent (Sigma Chemicals) in the wells of a 96-well plate and heated at 60° C. for 15 minutes. The absorbance at 562 nm was read using a plate reader and the weight of protein was estimated by comparison with a calibration curve.

Protein loading of fibres was achieved by suspension of powdered ovalbumin (OVA, Sigma) in a 10% PCL solution to give a suspension concentration of 1% w/v. Fibre spinning was subsequently carried out using the suspension.

Protein release characteristics were determined by incubating OVA-loaded fibres in phosphate buffered saline (PBS) at 37° C. and assaying the release medium for protein content at day 1, 2 and 7 using the BCA assay.

The amount of protein exposed at the surface of OVA-loaded fibres after incubation in PBS for 1, 2 and 7 days respectively, was determined by direct assay of fibres as described above for gelatin-coated fibres.

Cell interaction with PCL fibres was assessed using cell culture methods. Fibroblasts (Swiss 3T3 cells) and myoblasts (C9C12) at a density of 40,000/ml, were each seeded onto PCL fibres contained in 24-well plates. Tissue culture plastic (TCP) was used as a control. The number of attached cells was counted at time periods up to 8 days. At each time point, non-adherent cells were removed by washing in PBS. PCL fibre samples and TCP with attached cells were subsequently treated with Zaponin (Sigma Chemicals) to lyse the attached cells and the cell nuclei were counted using a Coulter counter. Cell attachment was subsequently quantified in terms of cell number/fibre area.

Separate samples of PCL fibres with attached cells were dried using a graded series of ethanol/water mixtures and shadowed with gold prior to examination of cell morphology using SEM.

Additionally, cell interaction and growth of human umbilical vein endothelial cells (HUVECs) on as-spun PCL fibres (150 μm fibres produced using a 10% (w/v) solution of PCL in acetone) were investigated using cell culture methods to assess the biocompatibility of PCL fibres and their potential as scaffold materials for soft tissue engineering. HUVECs were seeded at a density of 50,000/ml onto PCL fibres wrapped around 22 mm×22 m glass coverslips contained in 6-well plates (Costar). Tissue culture plastic (TCP) was used as a control. The number of attached cells was counted at 1, 2, 4, 7 and 9 days. At each time point, non-adherent cells were removed by washing the samples in HBSS (Gibco). PCL fibre samples and TCP with attached cells were subsequently treated with trypsin (Gibco) for 5 minutes to detach the cells and the cell number was counted using a haemocytometer (Imp. Neubauer. Weber Scientific Int. Ltd). Cell attachment was subsequently quantified in terms of cell number/fibre surface area, the fibre contact area being estimated using 50% of the fibre circumference.

Production of PCL Fibres.

A pre-weighed amount of poly(ε-caprolactone) was dissolved in a selected solvent (e.g. acetone) and made up to a predetermined volume to give a polymer solution of a desired concentration. The polymer solution was added to a reservoir of a spinneret having an adjustable flow control. Conveniently the spinneret may be produced from glass having a cylindrical barrel (reservoir section) (95 mm long×7 mm internal diameter) tapering to a capillary (50 mm long×1 mm internal diameter). The free end of the capillary of the spinneret was positioned in a bath containing non-solvent (e.g. methanol) such that it was immersed in the non-solvent. The polymer solution was allowed to flow under gravity through the capillary of the spinneret into the non-solvent bath so as to form a fibre. The ‘as spun’ fibre was taken up on a variable speed mandrel positioned above the non-solvent bath.

The method was varied as necessary to incorporate one or more additives into the polymer solution. If desired, the as-spun fibres were subsequently drawn to modify fibre properties such as tensile strength and morphology.

The method of the invention avoids pressurised flow conditions which can disrupt flow of the solution and produce fibre surface irregularities. This in turn can interfere with cell attachment and growth on the fibre. In addition the low shear conditions avoid shear-induced degradation of biopharmaceuticals such as polypeptide growth factors which may be included in the spinning solution.

Modification of fibre surface topography was achieved by wrapping wet as-spun PCL fibres around a mandrel submerged in the methanol bath prior to the fibre drying stage. The mandrel surface exhibited a machined topography characterised by a peak-to-peak separation of 91 μm and a peak height of 30 μm.

### Comparative Examples

Production of Poly(α-Hydroxy Acid) Fibres.

Solution Spinning of Poly(α-Hydroxy Acid) Polymers.

Dry spun PLA fibres have been produced by extrusion of polymer solutions in toluene at 110° C. through a conical capillary with diameter 1 mm, followed by drying at room temperature and hot drawing (Eling, B. supra). As-spun fibres were produced at rates between 0.25 and 0.35 m/min. PLA fibres with molecular weight (Mw) below 3.5×10⁵ could not be obtained due to the low solution viscosity at 110° C. PLA fibres have also been produced by dry spinning from solution in good solvents such as dichloromethane at rates between 0.02 and 1 m/min, followed by hot drawing (Gogolewski, S and Pennings, A. J, Resorbable materials of poly(L-lactide) II, Fibres spun from solutions of poly(L-lactide) in good solvents, J. App. Pol. Sci. 28 (1983) 1045-1061). A similar dry spinning method for PLA fibres was described by Fambri et al supra which involved extrusion of chloroform solutions through a needle of internal diameter 1 mm and length 15 mm at rates between 0.01 and 2 m/min. As-spun fibres were subsequently hot drawn at temperatures between 150 and 210° C. PLA fibres having a loosened fibrillar structure, to increase degradation rate, have been produced by incorporation of additives such as camphor or polyester urethanes in the PLA solution prior to dry spinning (Leenslag, J. W et al supra).

Melt Spinning

Melt spun PLA fibres have been produced at rates between 0.25 and 0.35 m/min by extrusion of a polymer cylinder at 185° C. through a capillary with diameter 1 mm and length 10 mm (Eling, B. supra)., Fibres could not be produced at temperatures above 185° C. because of the low melt viscosity.

Properties of PLA Fibres

The tensile strength and morphology of PLA fibres dry spun from solution were found to be strongly dependent on the molecular weight and concentration of PLA in the spinning solution and upon the draw ratio/temperature. Fibres of PLA with high tensile strength (1.2 GPa) and Young modulus (12-15 GPa) have been produced by hot drawing solution spun fibres (Eling et al, supra). At least one PLA fibre product (‘Lacton’ from Kanebo Goshen) is commercially available. However, PLA fibres suffer from low compliance (Leenslag et al, supra), a tendency to degrade during melt processing and the starting polymer is expensive.

Melt Spinning of PCL Fibres

FIG. 1 (Hutmacher et al., supra) shows the typical smooth surface topography of melt spun PCL fibres. Plate a) of FIG. 1 is a freeze fracture cross-sectional surface and plate b) is a top view of a PCL scaffold with a 0/60/120° lay down pattern.

### EXAMPLES

Fibre Processing/Properties Relationships.

The production rate of continuous PCL fibres under various process conditions was established by systematic variation of the solvent/non-solvent system, PCL molecular weight and solution concentration. In the following experiments the solvent used was acetone, and the non-solvent used was methanol unless otherwise stated.

PCL fibres were produced continuously at speeds typically ranging from 0.8 to 2.5 m/minute. The maximum rate of fibre production was found to be influenced by the nature of the solvent/non-solvent system, PCL molecular weight and the solution concentration, the effect of solution concentration being shown in Table 1. Fibre production rate was higher at low solution concentration in line with the higher flow rate of the lower viscosity solutions.

TABLE 1
Production rates of as-spun PCL fibres.

| PCL conc. | Fibre production rate | Fibre diameter |
|---|---|---|
| (% w/v) | (m/min) | (μm) |
| 5 | fibres not formed | |
| 6 | 1.5-3.5 | 140-240 |
| 10 | 1.5-2.7 | 150 |
| 15 | 1.3-2.5 | 150 |
| 20 | 0.9 | 150 |

Fibre Dimensions and Morphology.

As-spun PCL fibres are roughly circular in cross-section and exhibit a rough, porous surface (FIG. 2). This is in contrast to the smooth surface exhibited by melt-spun PCL fibres (FIG. 1). Molecular weight of the polymer used affects the physical characteristics of the as spun fibres produced by a discontinuous method: Table 2 shows as spun fibre production rate and diameter data for PCL fibres formed from polymer having a mean molecular weight (MW) of 37,000. Table 2 shows that in general fibres produced from polymers of lower molecular weight have a reduced diameter.

In addition, alteration of the spinneret capillary orifice diameter was found to directly affect the diameter of as-spun fibres. Halving the orifice diameter from 1 mm to 0.5 mm resulted in a halving of the diameter of as-spun fibres produced from 10% w/v solutions.

TABLE 2
Production rates of as-spun PCL fibres. Spinning rates
determined for discontinuous production of 200 mm lengths
of fibre using MW 37,000 fibre.

| PCL conc. | Fibre production rate | Fibre diameter |
|---|---|---|
| (% w/v) | (m/min) | (μm) |
| 5 | fibres not formed | |
| 10 | 1.0 | 100 |
| 15 | 0.6 | 117 |
| 20 | 0.5 | 107 |
| 25 | 0.3 | 123 |

Fibre tensile Properties

The effect of fibre spinning conditions on the tensile properties of as-spun fibres is shown in Table 3. As-spun PCL fibres produced from 20% w/v solutions were found to exhibit a Young modulus of 0.1 GPa, Ultimate Tensile Strength (UTS) of 9.9 MPa and elongation at break of approximately 600%. Whereas, PCL fibres produced from 6% w/v solutions where found to have a Young modulus of 0.01 GPa, Ultimate Tensile Strength (UTS) of 1.8 MPa and elongation at break of approximately 175%. This data shows that solution concentration can have a considerable effect on physical characteristics. Variation in the physical characteristics of the fibres may be useful in the production of suture materials, variations in the strength of the fibres may make them useful for different textile applications.

TABLE 3
The tensile properties of as-spun PCL fibres

| Soln conc (% w/v) | 6 | 10 | 15 | 20 |
|---|---|---|---|---|
| Yield stress (MPa) | 1.0 | 3.8 | 2.9 | 5.0 |
| % extension at yield | 17.1 | 10.8 | 15.9 | 8.7 |
| Failure stress (MPa) | 1.8 | 7.9 | 6.1 | 9.9 |
| % failure extension | 175.4 | 514.9 | 429.0 | 596.1 |
| E-modulus (GPa) | 0.01 | 0.08 | 0.04 | 0.1 |

The effect of cold drawing on PCL fibre tensile properties is indicated in Table 4. The general trend is an increase in tensile strength and stiffness and a decrease in failure extension with increasing draw ratio or extension.

TABLE 4
The tensile properties of drawn PCL fibres

| Spun from 6% solution | | | | |
|---|---|---|---|---|
| % extension | 50 | 100 | 200 | 500 |
| Yield stress (MPa) | 6.5 | 8.4 | 15.0 | N/A |
| Failure stress (MPa) | 12.3 | 13.7 | 20.0 | N/A |
| % failure extension | 260.1 | 188.2 | 107.6 | N/A |
| E-modulus (GPa) | 0.06 | 0.09 | 0.1 | N/A |
| Spun from 10% solution | | | | |
| % extension | 50 | 100 | 200 | 500 |
| Yield stress (MPa) | 5.7 | 8.1 | 17.0 | 31.7 |
| Failure stress (MPa) | 10.0 | 15.3 | 29.0 | 42.7 |
| % failure extension | 330.0 | 266.9 | 369.2 | 140.5 |
| E-modulus (GPa) | 0.04 | 0.05 | 0.12 | 0.31 |
| Spun from 15% solution | | | | |
| % extension | 50 | 100 | 200 | 500 |
| Yield stress (MPa) | 5.2 | 8.8 | 14.3 | 32.7 |
| Failure stress (MPa) | 8.2 | 16.3 | 21.7 | 47.0 |
| % failure extension | 213.5 | 260.3 | 302.8 | 148.2 |
| E-modulus (GPa) | 0.05 | 0.11 | 0.11 | 0.24 |
| Spun from 20% solution | | | | |
| % extension | 50 | 100 | 200 | 500 |
| Yield stress (MPa) | 8.0 | 13.0 | 22.3 | 29.3 |
| Failure stress (MPa) | 16.7 | 23.0 | 37.0 | 39.0 |
| % failure extension | 607.6 | 338.4 | 338.7 | 136.3 |
| E-modulus (GPa) | 0.09 | 0.16 | 0.24 | 0.32 |

Thermal Properties of PCL Fibres.

The melting point (Tm) and percentage crystallinity of as-spun PCL fibres produced from acetone solutions of various concentrations are presented in Table 5. The Tm remained fairly consistent at around 56 ° C. The crystallinity of the fibres tended to increase with increases in concentration of the spinning solution.

TABLE 5
The thermal properties of as-spun PCL fibres

| Solution conc. (% w/v) | 6 | 10 | 15 | 20 |
|---|---|---|---|---|
| Tm (° C.) | 57.0 | 55.6 | 55.9 | 57.8 |
| % crystallinity | 63.7 | 66.2 | 74.1 | 75.3 |

Surface Modification of PCL Fibres by Proteins.
Gelatin Coating of PCL Fibres.

The amount of gelatin (used as a representative protein) adsorbed on the surface of as spun 150 μm PCL fibres produced using a 10% (w/v) solution of PCL in acetone following coating using various concentration protein solutions is shown in Table 6. The lower the gelatin solution concentration, the more gelatin was adsorbed. PCL fibres surface modified with extra cellular matrix proteins or cell adhesion ligands may be useful in modulating cell/fibre interaction and tissue development either in vivo or in vitro.

TABLE 6
Gelatin adsorption on PCL fibres produced from a 10% w/v
solution of PCL in acetone

| Conc. of gelatin coating solution | Wt gelatin/fibre surface area |
|---|---|
| (% w/v) | (μg/mm²) |
| 5 | 3.9 |
| 10 | 1.8 |
| 20 | 0.7 |

OVA-Loaded PCL Fibres.

The amount of OVA exposed at the surface of OVA-loaded fibres (150 μm fibres produced using a 10% (w/v) solutioniof PCL in acetone) and the amount of OVA released into PBS at 37° C. increased with incubation time, as shown in Table 7. These findings demonstrate a capacity for controlled presentation and release of proteins from the fibres. The fibres may be used for the controlled delivery over time of an-array of therapeutic agents such as those referred to earlier.

TABLE 7
OVA exposure at the surface of protein-loaded fibres and release
in PBS at 37° C.

| | |
|---|---|
| Time in PBS | Wt OVA/fibre surface area OVA release |

| | | |
|---|---|---|
| (days) | (μg/mm²) of fibre | (μg protein/mg of fibre) |

| | | |
|---|---|---|
| 1 | 1.4 | 3.4 |
| 2 | 4.8 | 6.0 |
| 7 | 9.3 | 15.8 |

Progesterone-Loaded PCL Fibres

Steroid-loaded PCL fibres were produced by gravity spinning using a 12.5% w/v solution of PCL in acetone containing 5% w/v of progesterone (4-pregnene-3,20 dione, Sigma Chemicals). Methanol was used as the non-solvent and the fibre spinning rate was 2.1 m/min. As-spun fibres were air dried for 2 days prior to testing. The release rate of progesterone from PCL fibres was investigated by incubating 35 mg of fibres in 5 ml PBS at 37° C. The release medium was analysed at intervals for steroid content by measuring the absorbance at 248 nm using a UV spectrophotometer and comparing with a calibration curve. The amounts of progesterone release (μg/ml) were measured over 24 hours and are shown in Table 8 below.

The activity of released steroid was assessed by measuring its effect on breast cancer cells in cell culture. Progesterone is known to retard growth of these cells. Breast cancer cells (MCF-7 breast epithelial cells) were seeded at a density of 2×10 4 in 24-well tissue culture plates and allowed to attach and proliferate for 1 day. 30 mgs of steroid-loaded fibre were incubated in 5 ml of culture medium (Dulbecco MEM, ‘Invitron’) at 37° C. for 4 days. 0.5 ml aliquots of the release medium were added to each sample well and the cell growth rate was monitored over 3 days by cell counting (Neubauer haemocytometer, Appleton Woods). The cell proliferation rates over 3 days following addition of steroid released from PCL fibres are shown in FIG. 3 together with control (TCP and PCL fibres with no steroid added). Inhibition of cell growth was observed demonstrating that the activity of progesterone was retained after fibre spinning and following in vitro release from the PCL fibres.

TABLE 8
progesterone release from gravity spun PCL fibre

| | Cumulative Progesterone |
|---|---|
| Time | Release |
| Hrs | μg |
| 2 | 125.2 |
| 4 | 210.9 |
| 8 | 341.1 |
| 14 | 463 |

PCL Fibre/Cell Interaction.

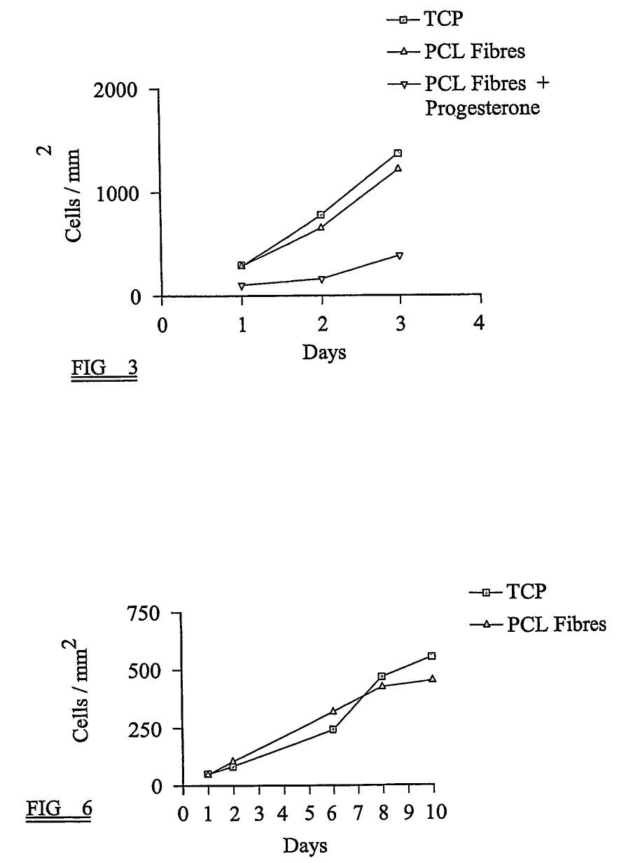

Myoblasts were found to attach and grow in greater numbers initially (2-7 days) on as-spun PCL fibres (150 m fibres produced using a 10% (w/v) solution of PCL in acetone) relative to TCP controls (FIG. 4) and cell numbers per unit area were equivalent at day 8. The number of fibroblasts attached to PCL fibres was higher than on TCP at day 4 (FIG. 5). A large fall in cell number was measured at day 7 indicating confluence and contact inhibition. HUVECs showed (FIG. 6, average of 6 replicates) comparable or greater attachment initially (1 to7 days), although there was subsequent growth (days 8 to 10) this was marginally less than that achieved by the TCP control.

PCL fibres produced by the method of the invention proved to be favourable substrates for growth of fibroblasts and muscle cells. This property combined with the high fibre compliance recommends their use for soft tissue reconstruction. The surface architecture of the fibres can be modified by, for example, spinning onto a mandrel having specific surface topography. This can enhance contact guidance of cells and improve the fibres as substrates for cell growth.

Cell attachment and growth on biomaterials is known to be influenced by surface physico-chemical properties (e.g. surface chemistry, hydrophobicity), microstructure (e.g. porosity) and the macrostructure or surface topography which gives rise to contact guidance effects.

Modification of PCL fibre surface topography was achieved by wrapping wet as-spun PCL fibres around a mandrel submerged in the methanol bath prior to the fibre drying stage. This facility enables the control of fibre surface architecture or texture for modulating cell attachment and orientation via contact guidance effects. FIG. 7 illustrates how the surface is modified (cf. FIG. 2).

Further potential uses for fibres producible by the methods of the present invention include:
Hard (e.g. bone) and soft tissue engineering (e.g. blood vessels, muscle, nerves),
suture materials
textile vascular grafts, and
biodegradable fibres for textiles manufacture.

1. A method of producing a polymeric fibre comprising:
(i) dissolving at least one fibre forming polymer in a solvent so as to form a polymer solution, and
(ii) feeding the polymer solution under gravity through an orifice directly into a non-solvent whereby to cause formation of a polymeric fibre in the non-solvent.

2. The method as claimed in claim 1, wherein said at least one fibre-forming polymer is selected from a linear aliphatic polyester, a polylactide, a polyglycolide, their copolymers with either (i) an aliphatic polyester, or (ii) polymers formed from monomers other than linear aliphatic esters.

3. The method as claimed in claim 2, wherein said polymer is selected from poly(cεcaprolactone), poly(DL lactide co-glycolide) and poly(glycolide ε-caprolactone).

4. The method as claimed in claim 2, wherein the polymer formed from monomers other than linear aliphatic esters is selected from at least one of poly(glycolide trimethylene carbonate), poly(L-lactic acid-L-lysine), poly(DL-lactide-urethane), PLA/PEO copolymers, poly(ester-amide), a polyanhydride, a polyorthoester, a poly(ester-ether), a polyphosphazine, PHB, PHV and their copolymers, a poly(β-malic acid), a poly(amino acid), and an aliphatic or an aromatic polycarbonate.

5. A method of producing a poly(E-caprolactone) fibre comprising:
(i) dissolving poly(ε-caprolactone) polymer in a solvent whereby to form a poly(ε-caprolactone) solution, and
(ii) feeding the poly(ε-caprolactone) solution through an orifice directly into a non-solvent whereby to form said poly(ε-caprolactone) fibre.

6. The method as claimed in claim 5, wherein when the at least one fibre-forming polymer is poly(ε-caprolactone), said solvent is selected from one or more of acetone, ethyl acetate, dichloromethane, chloromethane and chloroform.

7. The method as claimed in claim 6, wherein when the at least one fibre-forming polymer is poly(ε-caprolactone) said non-solvent is selected from one or more of methanol, ethanol and water.

8. The method as claimed in claim 1, wherein the non-solvent is chosen such that the polymer solution is more dense than the non-solvent.

9. The method as claimed in claim 1, wherein step (i) involves dissolving at least one additional polymer.

10. The method as claimed in claim 1, wherein said at least one additional polymer is selected from poly(ε-caprolactone), PMMA, PU, poly(hydroxyethyl methacrylate), polyethylene glycol, polyethylene oxide, copolymers of poly(ethyleneoxide)-poly(propylene oxide), polyvinyl pyrrolidone.

11. The method as claimed in claim 1, wherein step (ii) is effected by feeding the polymer solution through the orifice simultaneously with a pre-formed fibre, such that the resultant fibre comprises a core of the pre-formed fibre surrounded by a fibre formed from the polymer solution.

12. The method as claimed in claim 11, wherein the pre-formed fibre is a polestar fibre.

13. The method as claimed in claim 1, wherein said solvent and non-solvent are miscible.

14. The method as claimed in claim 1, including an additional step of introducing into the solvent one or more additives prior to step (ii).

15. The method as claimed in claim 14, wherein said additional step is effected by low shear mixing.

16. The method as claimed in claim 1, comprising a step (iii) of applying at least one additive to the surface of the fibre formed in step (ii).

17. The method as claimed in claims 14, wherein the additive of said additional step and/or step (iii) is selected from one or more of a peptide, a protein, DNA, RNA, oligonucleotides, a polysaccharide including. inulin, starch, dextran, cellulose and derivatives, sugar spheres, extra-cellular matrix components including glycosaminoglycans collagen, gelatin and albumin, bioceramics including hydroxyapatite, carbonate hydroxyapatite, tricalcium phosphate, carbon, calcium carbonate, and Bioglass, PMMA powders, polyesters, biodegradable polymers including PLA and PLG, polyorthoesters, polyanhydrides and oligosaccharide ester derivatives, discontinuous fibrous additives including alumina, carbon and synthetic polymers including polyester, PGA and polydioxanone, polypeptide growth factors including transforming growth factor-β, VEGF, EGF, BMP, IGF, or DNA encoding for polypeptide growth factors, their synthetic analogues or conjugates with other molecules such as PEG, vaccine antigens, therapeutic antibodies, anti-coagulants, anti-cancer, anti-inflammatory, anti-bacterial and anti-viral agents, thrombolytic agents, hormones, decalcified freeze-dried bone and bioactive compounds for veterinary and agricultural use including pesticides, plant nutrients and growth hormones.

18. The method as claimed in claims 1, wherein said additional step and/or step (iii) includes adding one or more types of cell adhesion molecule.

19. The method as claimed in claim 18, wherein said cell adhesion molecules are selected from collagen, gelatin, fibronectin, vitronectin, laminin, elastin and their synthetic analogues including protein-silk polymers or conjugates of such molecules with hydrophobic moieties, synthetic analogues of biomolecules containing cell binding sequences, antibodies having affinity for specific cell receptors of interest and molecules having affinity for cell surface polysaccharides.

20. The method as claimed in claims 1, wherein the or each additive comprises one or more active agent and a carrier vehicle.

21. The method as claimed in claim 20, wherein the carrier vehicle is selected from sugar spheres, spheres produced from polysaccharides including dextran, inulin, starch, cellulose and derivatives, proteins including gelatin and albumin, and synthetic carrier particles including synthetic non-resorbable polymeric particulates, microspheres and nanospheres, carbon, bioceramics and magnetic particles.

22. A fibre producible by the method of:
(i) dissolving at least one fibre forming polymer in a solvent so as to form a polymer solution, and
(ii) feeding the polymer solution under gravity through an orifice directly into a non-solvent whereby to cause formation of a polymeric fibre in the non-solvent.

23. A biomedical implant or cell-support matrix incorporating a fibre producible by the method of:
(i) dissolving at least one fibre forming polymer in a solvent so as to form a polymer solution, and
(ii) feeding the polymer solution under gravity through an orifice directly into a non-solvent whereby to cause formation of a polymeric fibre in the non-solvent

24. The method as claimed in claim 5, wherein the non-solvent is chosen such that the polymer solution is more dense than the non-solvent.

25. The method as claimed in claim 5, wherein step (i) involves dissolving at least one additional polymer.

26. The method as claimed in claim 5, wherein step (ii) is effected by feeding the polymer solution through the orifice simultaneously with a pre-formed fibre, such that the resultant fibre comprises a core of the pre-formed fibre surrounded by a fibre formed from the polymer solution.

27. The method as claimed in claim 5, wherein said solvent and non-solvent are miscible.

28. The method as claimed in claim 5, including an additional step of introducing into the solvent one or more additives prior to step (ii).

29. The method as claimed in claim 5, comprising a step (iii) of applying at least one additive to the surface of the fibre formed in step (ii).

30. A poly(F-caprolactone) fibre producible by the method of:
(i) dissolving poly(p-caprolactone) polymer in a solvent whereby to form a poly(ε-caprolactone) solution, and
(ii) feeding the poly(ε-caprolactone) solution through an orifice directly into a non-solvent whereby to form said poly(F-caprolactone) fibre.

31. A biomedical implant or cell-support matrix incorporating a poly(ε-caprolactone) fibre producible by the method of:
(i) dissolving poly(ε-caprolactone) polymer in a solvent whereby to form a poly(ε-caprolactone) solution, and
(iii) feeding the poly(ε-caprolactone) solution through an orifice directly into a non-solvent whereby to form said poly(ε-caprolactone) fibre.
